(19) United States
(12) Patent Application Publication
(10) Pub. No.: US 2009/0142485 A1
(43) Pub. Date: Jun. 4, 2009

(54) Process for Making Biomedical Devices

(76) Inventors: Yu-Chin Lai, Pittsford, NY (US); Edmond T. Quinn, Rochester, NY (US); Weihong Lang, Amston, CT (US); Daniel M. Ammon, JR., Webster, NY (US); Jay F. Kunzler, Canadaigua, NY (US)

Correspondence Address: Bausch & Lomb Incorporated, One Bausch & Lomb Place, Rochester, NY, 14604-2701, US

(21) Appl. No.: 12/273,192

(22) Filed: Nov. 18, 2008

Related U.S. Application Data
(60) Provisional application No. 60/991,034, filed on Nov. 29, 2007.
(60) Provisional application No. 60/992,750, filed on Dec. 6, 2007.
(60) Provisional application No. 60/991,031, filed on Nov. 29, 2007.

(51) Int. Cl. B05D 5/06

(52) U.S. Cl. 427/162

(57) ABSTRACT

A process for treating a silicone hydrogel biomedical device, especially an ophthalmic lens such as a contact lens, involves: immersing the silicone hydrogel biomedical device with a mixture of an organic solvent and a hydrophilic, polymeric material, for a sufficient time that the device is swollen in volume by at least 30%; and removing the organic solvent from the device while retaining at least a portion of the hydrophilic polymeric material therein.

This application claims the benefit of Provisional Patent Application No. 60/991,034, which was filed Nov. 29, 2007, 60/991,031 which was filed Nov. 29, 2007 and 60/992,750 which was filed Dec. 6, 2007 all of which are incorporated by reference herein.

### FIELD OF THE INVENTION

The present invention relates to a process for making polymeric, silicone hydrogel biomedical devices, particularly ophthalmic devices including contact lenses, intraocular lenses and ophthalmic implants.

### BACKGROUND OF THE INVENTION

Hydrogels represent a desirable class of materials for the manufacture of various biomedical devices, including contact lenses. A hydrogel is a hydrated cross-linked polymeric system that contains water in an equilibrium state. Hydrogel lenses offer desirable biocompatibility and comfort. A silicone hydrogel is a hydrogel material including a silicone-containing monomer, the silicone containing monomer imparting higher oxygen permeability to the resultant hydrogel copolymer.

In a typical process for the manufacture of hydrogel polymeric ophthalmic devices, such as contact lenses, a composition containing a mixture of lens-forming monomers is charged to a mold and cured to polymerize the lens-forming monomers and form a shaped article. In the case of a silicone hydrogel, the lens-forming monomer mixture includes a silicon-containing monomer. This monomer mixture may further include a diluent, in which case the diluent remains in the resulting polymeric article. Additionally, some of these lens-forming monomers may not be fully polymerized, and oligomers may be formed from side reactions of the monomers, these unreacted monomers and oligomers remaining in the polymeric article. Such residual materials may affect optical clarity or irritate the eye when the ophthalmic article is worn or implanted, so generally, the articles are extracted to remove the residual materials. Hydrophilic residual materials can be extracted by water or aqueous solutions, whereas hydrophobic residual materials generally involve extraction with an organic solvent. One common organic solvent is isopropanol, a water-miscible organic solvent. Following extraction, the hydrogel lens article is hydrated by soaking in water or an aqueous solution, which may also serve to replace the organic solvent with water. The molded device can be subjected to machining operations such as lathe cutting, buffing, and polishing, as well as packaging and sterilization procedures.

An example of such a process for silicone hydrogel contact lenses is found in U.S. Pat. No. 5,260,000 (Nandu) et al., where silicone hydrogel contact lenses are cast from monomeric mixtures including n-nonanol or n-hexanol as a diluent, and subsequently extracted with isopropanol to remove any remaining diluent as well as unreacted monomers and oligomers.

The present invention provides a process for incorporating a hydrophilic polymer into a silicone hydrogel biomedical device. The hydrophilic polymer migrates to the device surface, rendering the surface more wettable, lubricious and biocompatible. In some cases, the hydrophilic polymer may be gradually released from the device over time, or may form an interpenetrating network with the device polymeric matrix.

Numerous publications disclose the inclusion of NVP as a lens-forming monomer in a silicone hydrogel contact lens. Examples include U.S. Pat. Nos. 5,260,000 and 5,486,579. This invention incorporates a longer-chained hydrophilic polymer, such as a PVP polymer, into the lens polymeric matrix.

U.S. Pat. No. 6,367,929 discloses adding to hydrophilic polymer, such as PVP, into a mixture of lens-forming monomers, and polymerizing the lens-forming monomers to entrap the hydrophilic polymer therein. However, it is difficult to mix PVP, especially larger amounts of PVP, with many silicone hydrogel lens-forming monomer mixtures, since such lens-forming mixtures may be highly hydrophobic. When a hydrophilic polymer such as PVP is not sufficiently mixed with the lens-forming monomers, the resultant lens is cloudy and unacceptable as an ophthalmic lens. The present invention is suitable for a much wider variety of silicone hydrogel device materials.

### SUMMARY OF THE INVENTION

This invention provides a process comprising, sequentially: (a) immersing a silicone hydrogel biomedical device with a mixture of an organic solvent and a hydrophilic, polymeric material, for a sufficient time that the device is swollen in volume by at least 30%; and (b) removing the organic solvent from the device while retaining at least a portion of the hydrophilic polymeric material therein. In step (a) the device may swell in volume by at least 50%, and even at least 100%. In step (b), the device shrinks in volume as the organic solvent is removed from the device.

The device is preferably, an ophthalmic lens, such as a silicone hydrogel contact lens.

The hydrophilic, polymeric material may include at least one member selected from the group consisting of PVP, PVA, PAA, and PEO. The hydrophilic, polymeric material may have an Mn of at least 500, or at least 1000, or even at least 3000.

According to certain embodiments, step may (a) includes soaking the device in a mixture including isopropanol, ethanol, or mixtures thereof.

According to certain embodiments, the process comprises, sequentially: (a) soaking a silicone hydrogel contact lens in an aqueous solution including an organic solvent and a hydrophilic polymer that swells the device in volume by at least 30%; (b) repeating step (a) with a solution including a lower concentration of organic solvent; and (c) soaking the lens in a solution lacking organic solvent for sufficient time to remove the organic solvent from the lens, whereby the hydrophilic polymer is retained in the lens.

According to certain embodiments, the process comprises, sequentially: (a) soaking a silicone hydrogel contact lens in an organic solvent so that the device is swollen in volume by at least 30%; and (b) soaking the lens, while swollen, in an aqueous mixture comprising the hydrophilic, polymeric material, for sufficient time to remove the organic solvent from the lens, whereby the hydrophilic polymer is retained in the lens.

According to certain embodiments, the hydrophilic, polymeric material comprises a non-ionic hydrophilic, polymeric material. According to additional embodiments, the hydrophilic, polymeric material comprises an acid-containing hydrophilic, polymeric material, such as of poly(methacrylic acid), poly(acrylic acid), poly(itaconic acid), poly(maleic acid), acid-containing derivatives of an amino acid, or copolymers thereof. Additionally, the device may be immersed in a mixture comprising a non-ionic hydrophilic, polymeric material and an acid-containing hydrophilic, polymeric material.

The silicone hydrogel biomedical device is the polymerization product of a monomer mixture comprising a silicon-containing device-forming monomer. According to certain embodiments, this monomer mixture may further include an acid containing device-forming monomer, such as (meth)acrylic acid or N-vinyloxycarbonylalanine.

According to certain embodiments, in step (b), organic solvent is removed by placing the device in water or an aqueous solution.

According to various embodiments, the process may further comprise (c) autoclaving the device lens in saline solution.

### DETAILED DESCRIPTION OF VARIOUS PREFERRED EMBODIMENTS

The present invention provides a method for making silicone hydrogel biomedical devices, especially ophthalmic biomedical devices. The term “biomedical device” means a device intended for direct contact with living tissue. The term “ophthalmic biomedical device” means a device intended for direct contact with ophthalmic tissue, including contact lenses, intraocular lenses and ophthalmic implants. In the following description, the process is discussed with particular reference to silicone hydrogel contact lenses, a preferred embodiment of this invention, but the invention may be employed for extraction of other polymeric biomedical devices.

Hydrogels comprise a hydrated, crosslinked polymeric system containing water in an equilibrium state. Accordingly, hydrogels are copolymers prepared from hydrophilic monomers. In the case of silicone hydrogels, the hydrogel copolymers are generally prepared by polymerizing a mixture containing at least one lens-forming silicone-containing monomer and at least one lens-forming hydrophilic monomer. Either the silicone-containing monomer or the hydrophilic monomer may function as a crosslinking agent (a crosslinking agent being defined as a monomer having multiple polymerizable functionalities), or alternately, a separate crosslinking agent may be employed in the initial monomer mixture from which the hydrogel copolymer is formed. (As used herein, the term “monomer” or “monomeric” and like terms denote relatively low molecular weight compounds that are polymerizable by free radical polymerization, as well as higher molecular weight compounds also referred to as “prepolymers”, “macromonomers”, and related terms.) Silicone hydrogels typically have a water content between about 10 to about 80 weight percent.

Examples of useful lens-forming hydrophilic monomers include: amides such as N,N-dimethylacrylamide and N,N-dimethylmethacrylamide; cyclic lactams such as N-vinyl-2-pyrrolidone; (meth)acrylated alcohols, such as 2-hydroxyethyl methacrylate, 2-hydroxyethyl acrylate and glyceryl methacrylate; (meth)acrylated poly(ethylene glycol)s; (meth)acrylic acids such as methacrylic acid and acrylic acid; and azlactone-containing monomers, such as 2-isopropenyl-4,4-dimethyl-2-oxazolin-5-one and 2-vinyl-4,4-dimethyl-2-oxazolin-5-one. (As used herein, the term “(meth)” denotes an optional methyl substituent. Thus, terms such as “(meth)acrylate” denotes either methacrylate or acrylate, and “(meth)acrylic acid” denotes either methacrylic acid or acrylic acid.) Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277, the disclosures of which are incorporated herein by reference. Other suitable hydrophilic monomers will be apparent to one skilled in the art.

Applicable silicone-containing monomeric materials for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Examples of applicable silicone-containing monomers include bulky polysiloxanylalkyl(meth)acrylic monomers. An example of such monofunctional, bulky polysiloxanylalkyl(meth)acrylic monomers are represented by the following Formula I:

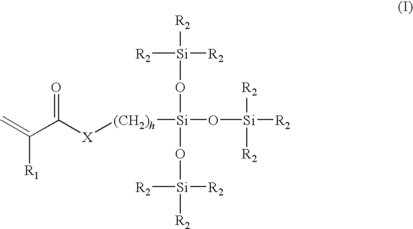

wherein:

X denotes —O— or —NR—;

each R₁ independently denotes hydrogen or methyl;

each R₂ independently denotes a lower alkyl radical, phenyl radical or a group represented by

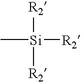

wherein each R₂′ independently denotes a lower alkyl or phenyl radical; and h is 1 to 10. One preferred bulky monomer is 3-methacryloxypropyl tris(trimethyl-siloxy)silane or tris(trimethylsiloxy)silylpropyl methacrylate, sometimes referred to as TRIS.

Another class of representative silicone-containing monomers includes silicone-containing vinyl carbonate or vinyl carbamate monomers such as: 1,3-bis[4-vinyloxycarbonyloxy)but-1-yl]tetramethyldisiloxane; 1,3-bis[4-vinyloxycarbonyloxy)but-1-yl]polydimethylsiloxane; 3-(trimethylsilyl)propyl vinyl carbonate; 3-(vinyloxycarbonylthio)propyl[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; and trimethylsilylmethyl vinyl carbonate.

An example of silicone-containing vinyl carbonate or vinyl carbamate monomers are represented by Formula II:

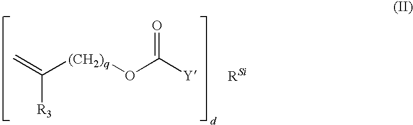

wherein:

Y′ denotes —O—, —S— or —NH—;

R^{Si} denotes a silicone-containing organic radical;

R₃ denotes hydrogen or methyl;

d is 1, 2, 3 or 4; and q is 0 or 1.

Suitable silicone-containing organic radicals R^{Si} include the following:

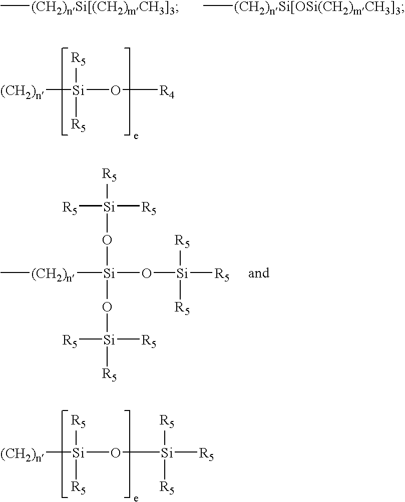

wherein:

R₄ denotes

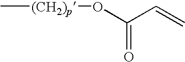

wherein p′ is 1 to 6;

R₅ denotes an alkyl radical or a fluoroalkyl radical having 1 to 6 carbon atoms;

e is 1 to 200; n′ is 1, 2, 3 or 4; and m′ is 0, 1, 2, 3, 4 or 5.

An example of a particular species within Formula II is represented by Formula III:

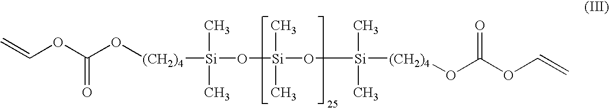

Another class of silicone-containing monomers includes polyurethane-polysiloxane macromonomers (also sometimes referred to as prepolymers), which may have hard-soft-hard blocks like traditional urethane elastomers. Examples of silicone urethane monomers are represented by Formulae IV and V:

E(*D*A*D*G)ₐ*D*A*D*E′; or (IV)

E(*D*G*D*A)ₐ*D*G*D*E′; (V)

wherein:

D denotes an alkyl diradical, an alkyl cycloalkyl diradical, a cycloalkyl diradical, an aryl diradical or an alkylaryl diradical having 6 to 30 carbon atoms;

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

denotes a urethane or ureido linkage;

a is at least 1;

A denotes a divalent polymeric radical of Formula VI:

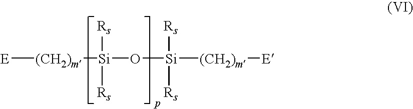

wherein:

each Rₛ independently denotes an alkyl or fluoro-substituted alkyl group having 1 to 10 carbon atoms which may contain ether linkages between carbon atoms;

m′ is at least 1; and

p is a number which provides a moiety weight of 400 to 10,000;

each of E and E′ independently denotes a polymerizable unsaturated organic radical represented by Formula VII:

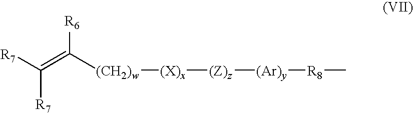

wherein:

R₆ is hydrogen or methyl;

R₇ is hydrogen, an alkyl radical having 1 to 6 carbon atoms, or a —CO—Y—R₉ radical wherein Y is —O—, —S— or —NH—;

R₈ is a divalent alkylene radical having 1 to 10 carbon atoms;

R₉ is a alkyl radical having 1 to 12 carbon atoms;

X denotes —CO— or —OCO—;

Z denotes —O— or —NH—;

Ar denotes an aromatic radical having 6 to 30 carbon atoms;

w is 0 to 6; x is 0 or 1; y is 0 or 1; and z is 0 or 1.

A more specific example of a silicone-containing urethane monomer is represented by Formula (VIII):

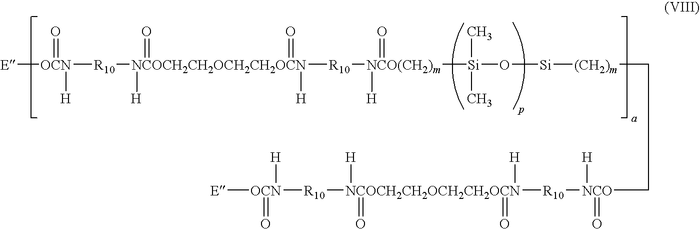

wherein m is at least 1 and is preferably 3 or 4, a is at least 1 and preferably is 1, p is a number which provides a moiety weight of 400 to 10,000 and is preferably at least 30, R₁₀ is a diradical of a diisocyanate after removal of the isocyanate group, such as the diradical of isophorone diisocyanate, and each E″ is a group represented by:

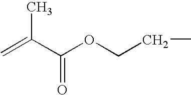

A preferred silicone hydrogel material comprises (based on the initial monomer mixture that is copolymerized to form the hydrogel copolymeric material) 5 to 50 percent, preferably 10 to 25, by weight of one or more silicone macromonomers, 5 to 75 percent, preferably 30 to 60 percent, by weight of one or more polysiloxanylalkyl (meth)acrylic monomers, and 10 to 50 percent, preferably 20 to 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 to Deichert et al. discloses additional unsaturated groups, including acryloxy or methacryloxy. Fumarate-containing materials such as those taught in U.S. Pat. Nos. 5,512,205; 5,449,729; and 5,310,779 to Lai are also useful substrates in accordance with the invention. Preferably, the silane macromonomer is a silicone-containing vinyl carbonate or vinyl carbamate or a polyurethane-polysiloxane having one or more hard-soft-hard blocks and end-capped with a hydrophilic monomer.

Specific examples of contact lens materials for which the present invention is useful are taught in U.S. Pat. No. 6,891,010 (Kunzler et al.); U.S. Pat. No. 5,908,906 (Kunzler et al.); U.S. Pat. No. 5,714,557 (Kunzler et al.); U.S. Pat. No. 5,710,302 (Kunzler et al.); U.S. Pat. No. 5,708,094 (Lai et al.); 5,616,757 (Bambury et al.); 5,610,252 (Bambury et al.); 5,512,205 (Lai); 5,449,729 (Lai); U.S. Pat. No. 5,387,662 (Kunzler et al.); U.S. Pat. No. 5,310,779 (Lai); and U.S. Pat. No. 5,260,000 (Nandu et al.), the disclosures of which are incorporated herein by reference.

Generally, the monomer mixtures may be charged to a mold, and then subjected to heat and/or light radiation, such as UV radiation, to effect curing, or free radical polymerization, of the monomer mixture in the mold. Various processes are known for curing a monomeric mixture in the production of contact lenses or other biomedical devices, including spincasting and static casting. Spincasting methods involve charging the monomer mixture to a mold, and spinning the mold in a controlled manner while exposing the monomer mixture to light. Static casting methods involve charging the monomer mixture between two mold sections forming a mold cavity providing a desired article shape, and curing the monomer mixture by exposure to heat and/or light. In the case of contact lenses, one mold section is shaped to form the anterior lens surface and the other mold section is shaped to form the posterior lens surface. If desired, curing of the monomeric mixture in the mold may be followed by a machining operation in order to provide a contact lens or article having a desired final configuration. Such methods are described in U.S. Pat. Nos. 3,408,429, 3,660,545, 4,113,224, 4,197,266, 5,271,875, and 5,260,000, the disclosures of which are incorporated herein by reference. Additionally, the monomer mixtures may be cast in the shape of rods or buttons, which are then lathe cut into a desired shape, for example, into a lens-shaped article.

Following casting of the device, the article is typically extracted to remove undesired extractables from the device. For example, in the case of contact lenses made from a silicone hydrogel copolymer, extractables include any remaining diluent, unreacted monomers, and oligomers formed from side reactions of the monomers.

In the process of this invention, the contact lens is immersed in a mixture comprising an organic solvent and a hydrophilic polymer for a sufficient time that the device is swollen in volume by at least 30%, more preferably by at least 50%, and most preferably by at least 100%. It is preferred the contact lens is soaked in the organic solvent, or a solution containing the organic solvent, for sufficient time that the contact lens copolymeric material reaches equilibrium therewith. 100341 Examples of suitable organic solvents are ethanol or isopropanol, which are particularly effective at swelling the contact lens polymeric material. Additional organic solvents are listed in the following table.

| | Flash Point | Vapor Pressure |
|---|---|---|
| Compound | (° C.) | (mmHg@25° C.) |
| Isopropanol | 11 | 20.48 |
| Dipropylene glycol | 137 | 0.01 |
| Dipropylene glycol monomethyl ether | 74 | — |
| Diethylene glycol monobutyl ether | 100 | 0.02 |
| Diethylene glycol monopropyl ether | — | 0.06 |
| Diethylene glycol monoethyl ether | 96 | 0.14 |
| Diethylene glycol monomethyl ether | 83 | 0.17 |
| Diethylene glycol monovinyl ether | 82 | 0.06 |
| Hexylene glycol | 93 | 0.04 |
| 2-methyl-butanol | 43 | 16.57 |
| 3-methyl-butanol | 45 | 2.94 |
| 3-pentanol | 40 | — |
| 4-methyl-2-pentanol | 40 | — |
| 2-methoxy-ethanol | 46 | 8.63 |
| 3-methoxy-1-butanol | 46 | 1.07 |

The treatment of the contact lenses may be effected with a mixture of two or more of the organic solvents, and the organic solvent may be included in an aqueous solution. The contact lenses may be immersed in the organic solvent at or near ambient temperature (25° C.) and pressure conditions (1 atm), or if desired, at elevated temperature or pressure. If desired, this step may be carried out in the receptacle of a contact lens blister package, or in another vessel.

Following treatment of the lens with the organic solvent, organic solvent is removed from the lens while retaining at least a portion of the hydrophilic polymeric material therein. This step is most conveniently performed by soaking the lens in water or aqueous solution (such as buffered saline) for sufficient time that water replaces the organic solvent. This operation may be performed at ambient conditions, or if desired, may be accompanied by heat and/or mixing. Since the lens polymeric material was initially swollen by the organic solvent, the lens polymeric material is able to absorb the hydrophilic material therein. The subsequent operation of removing the organic solvent results in shrinking of the lens polymeric material and the consequential retention of the hydrophilic material therein.

Suitable hydrophilic, polymeric materials include PVP, PVA (polyvinyl alcohol), PAA (polyacrylic acid), PEO (polyethyleneoxy), copolymers of PVP, PVA, PAA and PEO, and mixtures thereof. This material may be provided in water or an aqueous solution such as buffered saline solution.

Following this treatment, the contact lens is packaged and sterilized (for example, by autoclaving) according to conventional methods.

The following examples illustrate various preferred embodiments of this invention. The following abbreviations are used in the illustrative examples.
ID2S4H—a polyurethane-based prepolymer endcapped with 2-methacryloxyethyl (derived from isophorone diisocyanate, diethylene glycol, a polydimethylsiloxanediol, and 2-hydroxyethyl methacrylate according to U.S. Pat. No. 5,034,461).
TRIS—3-methacryloxypropyl tris(trimethylsiloxy)silane
DMA—N,N-dimethylacrylamide
NVP—N-vinyl pyrrolidone
GMA—glycidyl methacrylate
PVP—poly (N-vinyl pyrrolidone)
HemaVC—methacryloxyethyl vinyl carbonate
Hema—2-hydroxyethylmethacrylate
IMVT—1,4-bis (4-(2-methacryloxyethyl) phenylamino) anthraquinone (described in U.S. Pat. No. 4,997,897), a blue visibility-tinting agent
UV-Agent—2-(2′hydroxy-5′-methacrylxypropylphenyl)-5-chloro-2H-benzotriazole
IPA—isopropyl alcohol
MAA—methacrylic acid
M2D6—a polydimethylsiloxane, containing about six dimethylsiloxane units, and endcapped with 4-methacryloxybutyloxy
AIBN—azobisisobutyronitrile (Vazo-64 initiator)

### EXAMPLE 1

### Lens Casting

A master batch of monomer mixture is prepared from the components listed in Table 1. The amounts in Table 1 are parts by weight percent (pbw) unless otherwise noted.

TABLE 1

| Component | Parts by Weight |
|---|---|
| ID2S4H | 11 |
| TRIS | 35 |
| DMA | 11 |
| NVP | 40 |
| HemaVC | 0.5 |
| Hema | 5 |
| 3-methoxy-1-butanol | 3 |
| IMVT | 150 ppm |
| UV-agent | 0.5 |

To a portion of this master batch was added 0.5 wt % Vazo-64 initiator (control). To 107 parts of this master batch were added the following additional components: Mixture 1-1 part by weight MAA and 0.5 wt % Vazo-64 initiator; Mixture 2-1.5 parts by weight MAA and 0.5 wt % Vazo-64 initiator; Mixture 3-2 parts by weight MAA and 0.5 wt % Vazo-64 initiator.

Dosages of these monomer mixtures were placed between anterior and posterior contact lens molds, and thermally cured at 70° C. Following curing, the posterior mold sections were removed, and the contact lenses were released from the anterior mold sections.

### EXAMPLE 2

### Lens Treatment

The lenses cast in Example 1 were soaked for two cycles in a solution of 3-methoxy-1-butanol including 1 weight percent PVP (Mn 360,000) at 60° C., for 3 minutes each cycle. During this time, the lenses were swollen more than 40% in dimensions. The lenses where then placed in deionized water, and the lenses quickly shrunk. They were then placed in borate buffered saline and autoclaved. As a control, lenses were also extracted in the same solvent but without the PVP, and then placed in water and autoclaved in borate buffered saline. All lenses were inspected manually by rubbing the lenses between fingers.

All lenses extracted with 3-methoxy-1-butnaol containing PVP showed better lubricity than the control lenses extracted without the presence of PVP. Also, Lenses from Mixture 3 (2 pbw MAA) showed the highest lubricity. Lenses from Mixtures 2 (1.5 pbw MAA) and Mixture 1 (1 pbw MAA) had better lubricity than lenses from the Control Mixture (0 pbw MAA).

### EXAMPLE 3

### Lens Treatment

Example 2 was repeated except PVP (Mn 50,000) in isopropanol was used for the lens treatment. After full processing, the lenses were much more lubricious than the control lenses extracted with isopropanol alone.

### EXAMPLE 4A

### Treatment of Balafilcon A Contact Lenses

Plasma treated balafilcon A contact lenses were provided. Balafilcon A is a silicone hydrogel copolymer and disclosed in U.S. Pat. No. 5,260,000. The lenses were then treated in the following manner.

Treatment A—Lenses were extracted in a solution of IPA with 5% PVP, 5 ml/lens, for 110 minutes. The lenses were then hydrated in deionized water containing 5% PVP, two cycles of ten minutes.

Treatment B—Lenses were extracted in a solution of IPA with 5% PVP, 5 ml/lens, for 110 minutes. The lenses were then hydrated in deionized water (no PVP).

Treatment C—Lenses were extracted in IPA (no PVP), dried to remove IPA, and hydrated in deionized water containing 5% PVP, two cycles of ten minutes.

Treatment D (control)—Lenses were extracted in IPA (no PVP), dried to remove IPA, and hydrated with deionized water (no PVP).

Subsequently, for each of the treatments, the treated lenses were then placed in borate buffered saline in a contact lens blister package and autoclaved for 1 cycle (30 minutes at 121° C.).

During the IPA extraction steps, the lenses expanded about 60% in dimensions. When then placed in deionized water, the lenses shrunk. PVP (Mn 50,000) was used. It was observed that lenses extracted with IPA containing PVP of Mn 50,000 were very lubricious. The fully processed lenses were also tested for in vitro lipid uptake and water content. Lenses treated with each of Treatments A, B and C showed lower in vitro lipid uptake than the control lenses (Treatment D). Water content of lenses from each of Treatments A, B, C and D was essentially the same.

### EXAMPLE 4B

Balafilcon A contact lenses were treated as in Example 4A, except employing PVP (Mn 360,000). These lenses showed no or little improvement in lubricity, indicating the difficulty of penetrating a very high molecular weight molecule into a swollen lens polymer network.

### EXAMPLE 5

### Lens Treatment

1 gram of a copolymer of polyvinylpyrrolidone/dimethylaminoethyl methacrylate sulfate (14:1 molar ratio), having Mn over 1 million (supplied by Aldrich Chemical), was dissolved in 33 ml of water and 80 ml of isopropanol. This solution was slightly hazy, and contained 1% copolymer. The master solution was: 1) diluted with an equal amount of isopropanol to get 0.5% copolymer solution; 2) diluted 4 times with isopropanol to get 0.25% copolymer solution.

Balafilcon A contact lenses, as described in Example 4 but not plasma treated, were extracted overnight these solutions containing 1%, 0.5% and 0.25% PVP copolymer. It was observed the lenses swelled to different degrees, ranging from 14.0 to 21 mm in diameter. Subsequently, the lenses were rinsed in deionized water, and then autoclaved in borate buffered saline. These lenses were more lubricious than lenses extracted with isopropanol alone.

### EXAMPLE 6

### Lens Treatment

Silicone hydrogel contact lenses were cast from the formulation of Example 1 containing 2 parts by weight of methacrylic acid. These lenses were extracted overnight with the solutions in Example 5 containing 0.25%, 0.5% and 1% cationic PVP copolymer in isopropanol. The lenses were then rinsed with deionized water, and then autoclaved in borate buffered saline. These lenses were more lubricious than lenses extracted with isopropanol alone.

### COMPARATIVE EXAMPLE 1

A monomer mixture was prepared from the components listed in Table 2. The mixture appeared cloudy. 3-methoxy-1-butanol was added at 30 weight percent, at which point the mixture turned clear. Then, 1 weight percent Vazo initiator was added, and the mixture was cured between two silane-treated glass plates. The cured film was cloudy.

Separately, an unused portion of the monomer mixture was allowed to stand. Precipitate formed, indicating unacceptable solubility of the PVP in the monomer mixture.

TABLE 2

| Component | Parts by Weight |
|---|---|
| M2D6 | 11 |
| TRIS | 35 |
| DMA | 40 |
| Hema | 5 |
| PVP (Mn 360,000) | 5 |

### COMPARATIVE EXAMPLE 2

A monomer mixture was prepared from the components listed in Table 2, except that only I part by weight of the PVP was employed. The mixture appeared cloudy. 3-methoxy-1-butanol was added at 30 weight percent, at which point the mixture turned clear. After an hour, precipitate formed in the monomer mixture, indicating unacceptable solubility of the PVP in the monomer mixture.

Comparative Examples 1 and 2 show the difficulty of incorporating PVP (Mn 360,000) in a lens-forming monomer mixture, as compared to the methods of this invention.

### EXAMPLE 7

### Contact Lens Casting

Master batches of monomer mixtures are prepared from the components listed in Table 3. The amounts in Table 3 are parts by weight percent unless otherwise noted.

TABLE 3

| | Formulation A | Formulation B |
|---|---|---|
| Component | Parts by Weight | Parts by Weight |
| ID2S4H | 11 | 11 |
| TRIS | 35 | 35 |
| DMA | 11 | 11 |
| NVP | 40 | 40 |
| HemaVC | 0.5 | 0.5 |
| Hema | 5 | 5 |
| GMA | — | 3 |
| 3-methoxy-1-butanol | 3 | 3 |
| IMVT | 150 ppm | 150 ppm |
| UV-agent | 0.5 | 0.5 |

To a portion of these master batches was added 0.5 wt % AIBN. Dosages of these monomer mixtures were placed between anterior and posterior contact lens molds, and thermally cured at 70° C. Following curing, the posterior mold sections were removed, and the contact lenses were released from the anterior mold sections. Some of the contact lenses were retained as controls.

### EXAMPLE 8

### Lens Treatment

Lenses cast in Example 7 were subjected to the following treatments:

Treatment 1 (control)—Extracted in a solution of 3-methoxy-1-butanol at 60° C. for 3 minutes, and then in deionized water at 60° C. for 3 minutes.

Treatment 2—Extracted in a solution of 3-methoxy-1-butanol at 60° C. for 3 minutes, and then in deionized water containing 1 wt % polyacrylic acid (Mn 400,000) at 60° C. for 3 minutes.

Treatment 3—Extracted in a mixture of 3-methoxy-1-butanol and deionized water (50/50) at 60° C. for 3 minutes, and then in deionized water containing 1 wt % polyacrylic acid (Mn 400,000) at 60° C. for 3 minutes.

### EXAMPLE 9

### Contact Angle Measurement

The contact angle measurement for the control and tested lenses prepared in Example 8 was carried out as follows. The lenses were placed in polystyrene Petri dishes containing HPLC grade water for 15 minutes. The lenses were quartered using a clean scalpel. The quarters were mounted on a clean glass slide and dried overnight in a nitrogen dry-box. The contact angles were measured on the dehydrated lenses at two points on each quarter. The instrument used for the measurement was an AST Products Video Contact Angle System (VCA) 2500XE. This instrument utilizes a low power microscope that produces a sharply defined image of the water drop, which is captured immediately on the computer screen. HPLC water was drawn into the VCA system microsyringe, and a 0.6 μl drop is dispensed from the syringe onto the sample. The contact angle is calculated by placing three to five markers along the circumference of the drop and the contact angle is recorded. Both a right and left angle are reported for each measurement and an average was calculated and recorded. The results of this test are set forth below in Table 4, for both the anterior and posterior surfaces. Treatments 2 and 3 yielded better wettability than the control (treatment 1).

TABLE 4

| | Formulation A | | | Formulation B | |
|---|---|---|---|---|---|
| | Treatment | | Treatment | Treatment | Treatment |
| | 1 | Treatment 2 | 3 | 2 | 3 |
| Posterior | 111 (5) | 48 (18) | 70 (6) | 68 (10) | 87 (7) |
| Anterior | 112 (1) | 79 (18) | 100 (9) | 87 (3) | 102 (3) |

### EXAMPLE 10

### Lens Treatment

The lenses cast in Example 7, formulation A, are extracted for two cycles in a solution of 3-methoxy-1-butanol including 1 weight percent polyacrylic acid (Mn 400,000) at 60° C., 3 minutes per cycle. During this time, the lenses are swollen more than 40% in dimensions. Then they are placed in deionized water, and shrink quickly. They are then placed in borate buffered saline and autoclaved. The lenses are very wettable, and more wettable than lenses then treated under the conditions described in Example 8.

### EXAMPLE 11

### Treatment of Contact Lenses

Balafilcon A is a silicone hydrogel contact lens sold commercially under the trademark PureVision by Bausch & Lomb Incorporated. Balafilcon A contact lenses are soaked in a solution of IPA containing 0.5 weight percent PAA (Mn 50,000) and 1 weight percent PVP (Mn 360,000), for 4 hours. Then, the lenses are soaked in deionized water, followed by autoclaving.

Having thus described the preferred embodiment of the invention, those skilled in the art will appreciate that various modifications, additions, and changes may be made thereto without departing from the spirit and scope of the invention, as set forth in the following claims.

We claim:

1. A process comprising, sequentially:
(a) immersing a silicone hydrogel biomedical device with a mixture of an organic solvent and a hydrophilic, polymeric material, for a sufficient time that the device is swollen in volume by at least 30%; and
(b) removing the organic solvent from the device while retaining at least a portion of the hydrophilic polymeric material therein.

2. The process of claim 1, wherein in step (a), the device swells in volume by at least 50%.

3. The process of claim 2, wherein in step (a), the device swells in volume by at least 100%.

4. The process of claim 2, wherein in step (b), the device shrinks in volume as the organic solvent is removed from the device.

5. The process of claim 1, wherein the device is an ophthalmic lens.

6. The process of claim 1, wherein the device is a silicone hydrogel contact lens.

7. The process of claim 1, wherein the hydrophilic, polymeric material includes at least one member selected from the group consisting of PVP, PVA, PAA, and PEO.

8. The process of claim 1, wherein step (a) includes soaking the device in a mixture including isopropanol, ethanol, or mixtures thereof.

9. The process of claim 1, wherein the hydrophilic, polymeric material has an Mn of at least 500.

10. The process of claim 1, wherein the hydrophilic, polymeric material has an Mn of at least 1000.

11. The process of claim 1, wherein the hydrophilic, polymeric material has an Mn of at least 3000.

12. The process of claim 1, comprising, sequentially:
(a) soaking a silicone hydrogel contact lens in an aqueous solution including an organic solvent and a hydrophilic polymer that swells the device in volume by at least 30%.
(b) repeating step (a) with a solution including a lower concentration of organic solvent;
(c) soaking the lens in a solution lacking organic solvent for sufficient time to remove the organic solvent from the lens,
whereby the hydrophilic polymer is retained in the lens.

13. The process of claim 1, comprising, sequentially:
(a) soaking a silicone hydrogel contact lens in an organic solvent so that the device is swollen in volume by at least 30%; and
(b) soaking the lens, while swollen, in an aqueous mixture comprising the hydrophilic, polymeric material, for sufficient time to remove the organic solvent from the lens, whereby the hydrophilic polymer is retained in the lens.

14. The process of claim 1, wherein the hydrophilic, polymeric material comprises a non-ionic hydrophilic, polymeric material.

15. The process of claim 1, wherein the hydrophilic, polymeric material comprises an acid-containing hydrophilic, polymeric material.

16. The process of claim 1, wherein the acid-containing hydrophilic, polymeric material includes at least one member selected from the group consisting of poly(methacrylic acid), poly(acrylic acid), poly(itaconic acid), poly(maleic acid), acid-containing derivatives of an amino acid, and copolymers thereof.

17. The process of claim 1, wherein the device is immersed in a mixture comprising a non-ionic hydrophilic, polymeric material and an acid-containing hydrophilic, polymeric material.

18. The process of claim 1, wherein the silicone hydrogel biomedical device is the polymerization product of a monomer mixture comprising a silicon-containing device-forming monomer and an acid containing device-forming monomer.

19. The process of claim 18, wherein the monomer mixture includes at least one device-forming monomer selected from the group consisting of (meth)acrylic acid and N-vinyloxycarbonylalanine.

20. The process of claim 1, wherein in step (b), organic solvent is removed by placing the device in water or an aqueous solution.

21. The process of claim 19, further comprising (c) autoclaving the device lens in saline solution.
